(19) United States
(12) Patent Application Publication
(10) Pub. No.: US 2012/0262745 A1
(43) Pub. Date: Oct. 18, 2012

(54) PRINTING SYSTEM INCLUDING A PLURALITY OF IMAGE FORMING APPARATUSES CONNECTED WITH EACH OTHER, AND METHOD FOR CONTROLLING THE SAME

(75) Inventor: Akihiro Mitsui, Kawasaki-shi (JP)

(73) Assignee: CANON KABUSHIKI KAISHA, Tokyo (JP)

(21) Appl. No.: 13/427,112

(22) Filed: Mar. 22, 2012

(30) Foreign Application Priority Data
Apr. 15, 2011 (JP) 2011-091168

(51) Int. Cl. G06K 15/16

(52) U.S. Cl. 358/1.12

(57) ABSTRACT

The printing system is configured so that a sheet discharge unit of a first image forming apparatus is connected to a sheet feeding unit of a second image forming apparatus, and a sheet on which an image is formed by the first image forming apparatus is supplied to the second image forming apparatus changes order of image formation so that data to be printed on the same side is printed on the same side.

### BACKGROUND OF THE INVENTION

1. Field of the Invention

The present invention relates to a printing system including a plurality of image forming apparatuses connected with each other, more particularly a printing system capable of controlling order of image formation in consideration of the orientation of a print side when a printed sheet is discharged.

2. Description of the Related Art

Depending on the configuration of a reversing path, the orientation of a developing unit with respect to a print sheet, and the page where to start image formation when a job includes a plurality of pages, a printer may discharge a print sheet with its print side downward or with the print side upward. Hereinafter, a sheet output with its print side downward will be referred to as face down, and with the print side upward as face up.

Printers capable of two-sided printing can output print sheets either face down or face up, using a reverse discharge function.

If that printers having the same structure are used to perform two-sided printing, whether to print on the front side of a print sheet first or the back side first differs depending on whether to output the print sheet face up or face down. Two-sided printing using printers can thus result in different order of image formation with respect to input data.

For example, to output a sheet face up in two-sided printing, the back page, i.e., second page (even-numbered page) is first printed before the front page, i.e., first page (odd-numbered page) is printed. To output a sheet face down by using a printer having the same configuration, the front page or first page is printed first.

A single print job may be divided and performed by a plurality of printers for enhanced efficiency. In such a case, printed sides of the print sheets can be mixed up if printers that output print sheets face up and that outputs print sheets face down are used in combination.

An example will be described where a job including a total of eight pages is performed by a printer that outputs the first to fourth pages face down and a printer that outputs the fifth to eighth pages face up.

The first to fourth pages are output to a sheet discharge unit of the one printer face down. In other words, the sheet on which the first page and the second page are printed is discharged with the first page downward. The sheet on which the third page and the fourth page are printed is discharged thereon with the third page downward.

The fifth to eighth pages are output to a sheet discharge unit of the other printer face up. The sheet on which the fifth page and the sixth page are printed is discharged with the sixth page downward. The sheet on which the seventh page and the eighth page are printed is discharged thereon with the eighth page downward.

As a result, the discharged sheets are in the following order from the bottom: the sheet on which the first and second pages are printed (the first page downward); the sheet on which the third and fourth pages are printed (the third page downward); the sheet on which the fifth and sixth pages are printed (the sixth page downward); and the sheet on which the seventh and eighth pages are printed (the eighth page downward).

Next to the fourth page is the sixth page. As a result, the order of the pages is not correct at the pages where the sheets output from different printers are stacked.

Japanese Patent Application Laid-Open No. 10-35059 discusses a technique for forming and printing images of input data in descending order from the last page when using a printer that outputs printed sheets face up. When using a printer that outputs printed sheets face down, images of input data are formed and printed in ascending order from the first page. Printed sheets can be simply stacked up into an output result without reordering.

A printing system that includes a plurality of image forming apparatuses such as multifunction peripherals and printers has been developed. The image forming apparatuses are connected by cables or through interfaces that can directly connect the image forming apparatuses, so that image forming apparatuses having different functions can perform printing on a print sheet at a time.

For example, Japanese Patent Application Laid-Open No. 2008-145595 discusses an image processing system that includes an image processing apparatus for performing printing with color toners and an image processing apparatus for performing printing with clear toner. The image processing apparatuses are connected to constitute an image processing system that produces an output product by using clear toner. More specifically, the two image forming apparatuses include a first printing apparatus and a second printing apparatus. The first printing apparatus in the prior stage transfers and fixes first data onto a sheet by using C, M, Y, and K toners. The second printing apparatus transfers and fixes second data corresponding to the first data by using clear toner onto the sheet printed by using the C, M, Y, and K toners.

The sheet discharged from the first printing apparatus is fed to a sheet feed port of the second printing apparatus. The use of two image forming apparatuses enables high quality printing by using sufficient amounts of toners.

The above-described printing system may include an intermediate buffer for interconnection between a sheet discharge unit of the image forming apparatus in the prior stage and a sheet feeding unit of the image forming apparatus in the subsequent stage. With or without an intermediate buffer, a sheet passes therethrough in the same orientation as discharged from the image forming apparatus in the prior stage. In other words, an output product from the image forming apparatus in the prior stage is simply used as an input to the image forming apparatus in the subsequent stage.

There is no particular problem with one-sided printing if the plurality of image forming apparatuses constituting the printing system do not reverse a sheet, and discharge a sheet with the print side in the same orientation.

When the image forming apparatus in the prior stage and the image forming apparatus in the subsequent stage both perform two-sided printing, data to be printed on the same side of the same sheet may fail to be printed on the same side of the same sheet depending on the configurations of the sheet reversing paths of the respective image forming apparatuses.

The problem will be described more specifically below. First, the image forming apparatus in the prior stage outputs a print sheet face down, with the first page printed on the front side and the second page printed on the back side. That is, the sheet is output with the side where the second page is printed upward.

The print sheet is then fed to the image forming apparatus in the subsequent stage. The image forming apparatus in the subsequent stage first performs printing on the side where the second page is printed by the image forming apparatus in the prior stage, and then performs printing on the side where the first page is printed by the image forming apparatus in the prior stage.

In such a case, the image forming apparatus in the subsequent stage prints data corresponding to the data on the first page printed by the image forming apparatus in the prior stage not onto the same side but onto the second page. Similarly, the image forming apparatus in the subsequent stage prints data corresponding to the data on the second page printed by the image forming apparatus in the prior stage onto the first page.

In a case where the printing system includes a combination of an image forming apparatus that outputs a print sheet face up and an image forming apparatus that outputs a print sheet face down, a side printed by the image forming apparatus in the prior stage and a side printed by the image forming apparatus in the subsequent stage may fail to match even in one-sided printing.

This causes a problem because images to be printed on the same print side are not printed on the same print side.

As described above, a printing system in which a plurality of image forming apparatuses are connected can cause the above-described problem depending on the structures of the connected image forming apparatuses unless consideration is given to the orientation of a print side on a sheet when the connected image forming apparatuses discharge the sheet.

### SUMMARY OF THE INVENTION

According to an aspect of the present invention, there is provided a printing system configured so that a sheet discharge unit of a first image forming apparatus is connected to a sheet feeding unit of a second image forming apparatus and a sheet on which an image is formed by the first image forming apparatus is supplied to the second image forming apparatus, the first image forming apparatus being configured to form an image of first image data included in an input print job, the second image forming apparatus being configured to form an image of second image data included in the input print job, the printing system comprising: an input unit configured to input a print job including the first image data and the second image data; a decision unit configured to decide order of printing of the first image data for the first image forming apparatus to form an image of or the second image data for the second image forming apparatus to form an image of so that the second image data to be printed on the same side of a sheet output from the sheet discharge unit of the first image forming apparatus as where the first image data is printed is printed on the same side of the output sheet as where the first image data is printed; and a print unit configured to print the print job input by the input unit in the order decided by the decision unit.

According to the present invention, when the printing system including a plurality of image forming apparatuses connected with each other is operated, the order of images and the orientation of a print side when discharged according to characteristics of the image forming apparatuses connected with each other. A print can thus be output without mismatching between the print sides of the image forming apparatus in the prior stage and the image forming apparatus in the subsequent stage.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a printing system that includes two multifunction peripherals.

FIG. 2 is a diagram illustrating a configuration of printer hardware of a multifunction peripheral.

FIG. 3 is a diagram illustrating mismatching of print sides when the printing system simply performs two-sided printing.

FIG. 4 is a diagram illustrating print surfaces when the printing system performs two-sided printing in rearranged order of image formation.

FIG. 5 (5A+5B) is a flowchart illustrating a procedure for rearranging order of images and/or the orientation of a print side performed by a first multifunction peripheral of the printing system when discharged based on information acquired from a second multifunction peripheral.

FIG. 6 is a screen of a display device of the first multifunction peripheral of the printing system for designating the orientation of a print side when discharged.

FIG. 7 is a diagram illustrating a user interface of a driver of the printing system.

FIG. 8 (8A+8B) is a flowchart illustrating a procedure for changing order of images and/or designation of the orientation of a print side upon discharge by a first multifunction peripheral of a printing system for printing separate jobs based on information acquired from a second multifunction peripheral.

### DESCRIPTION OF THE EMBODIMENTS

Various exemplary embodiments, features, and aspects of the invention will be described in detail below with reference to the drawings.

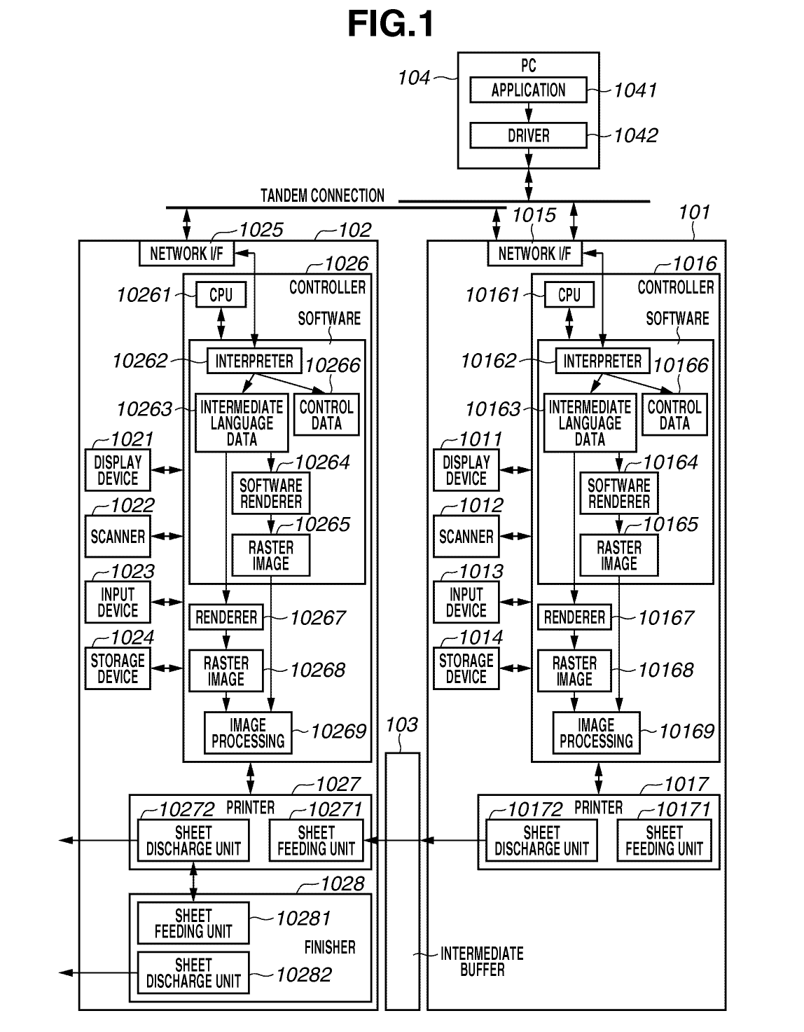

FIG. 1 is a block diagram illustrating a configuration of a printing system according to the present exemplary embodiment. The printing system includes a first multifunction peripheral 101 and a second multifunction peripheral 102. The first multifunction peripheral 101 is a first image forming apparatus connected to a personal computer (PC) 104 over a network. The second multifunction peripheral 102 is a second image forming apparatus connected to the multifunction peripheral 101 through a connection network.

The multifunction peripherals 101 and 102 each are an apparatus that implements a plurality of functions such as a copying apparatus, printing apparatus, and facsimile machine (FAX) by one apparatus. The multifunction peripheral 101 includes a display device 1011, a scanner 1012, and an input device 1013. The multifunction peripheral 102 includes a display device 1021, a scanner 1022, and an input device 1023.

In FIG. 1, two multifunction peripherals 101 and 102 are connected. However, a plurality of multifunction peripherals, not limited to two, may be connected. Further, the connected machines need not be exactly the same ones. For example, a color machine and a monochrome machine, an A3 machine and an A4 machine, and a multifunction peripheral and a printer may be included.

A sheet discharge unit 10172 of the first multifunction peripheral 101 is connected to a sheet feeding unit 10271 of the second multifunction peripheral 102 through an intermediate buffer 103. A printed sheet discharged from the first multifunction peripheral 101 is automatically fed into the second multifunction peripheral 102.

The PC 104 is connected to a network interface (I/F) 1015 of the first multifunction peripheral 101 through the network. The PC 104 includes an application 1041 and a driver 1042. The application 1041 uses the driver 1042 to transmit print data to the printing system where the plurality of multifunction peripherals 101 and 102 is connected. The print data includes first image data and second image data. The first image data is formed by the first multifunction peripheral 101. The second image data is formed by the second multifunction peripheral 102.

The print data is transmitted to the network I/F 1015 of the first multifunction peripheral 101. The second multifunction peripheral 102 acquires necessary data from the first multifunction peripheral 101.

The first multifunction peripheral 101 will be described in detail below. The first multifunction peripheral 101 acquires print data from the network I/F 1015, and transmits the print data to a controller 1016. The controller 1016 processes the print data by using both software and hardware.

A central processing unit (CPU) 10161 interprets the received print data by using an interpreter 10162. The CPU 10161 converts rendering data corresponding to a page description language (PDL) into intermediate language data 10163, and converts print settings corresponding to a printer job language (PJL) into control data 10166. Based on the settings of the control data 10166 and hardware configuration, the CPU 10161 selects whether to process the intermediate language data 10163 by software processing or by hardware processing.

In the case of software processing, a software renderer 10164 generates a raster image 10165 from the intermediate language data 10163. In the case of hardware processing, a renderer 10167 generates a raster image 10168.

Raster images generated by software and hardware have not much difference. Since detail reproducibility differs slightly, a more suitable renderer is used. Some multifunction peripherals may include only one renderer.

The generated raster image is subjected to image processing 10169 for color processing and/or halftone processing. The resultant image is transmitted to a printer 1017 along with the control data 10166.

The printer 1017 is connected with the controller 1016. The printer 1017 forms image data on a sheet by using toner. The printer 1017 includes a sheet feeding unit 10171 and the sheet discharge unit 10172. The sheet feeding unit 10171 feeds a sheet. The sheet discharge unit 10172 discharges a sheet on which image data is formed. The printer 1017 performs printing on a sheet by using toner based on input image data, and outputs the sheet.

The display device 1011 displays a user interface for displaying information to the user and displaying a status of the multifunction peripheral 101. The scanner 1022 includes an automatic document feeder. The scanner 1022 irradiates a bundle or a sheet of document image with a light source, forms a reflected document image on a solid-state image sensor such as a charge-coupled device (CCD) sensor through a lens, and acquires an image read signal from the solid-state image sensor as image data.

The input device 1013 is an interface for accepting inputs from the user. Examples of the input device 1013 include hardware keys and a touch panel. A storage device 1014 stores temporary information, the raster image 10168, and the intermediate language data 10163 in cooperation with the controller 1016.

If the controller 1016 determines that the printing system includes a plurality of multifunction peripherals connected with each other, and that the input print data includes information to be transmitted to the second multifunction peripheral 102, the controller 1016 transmits data to the second multifunction peripheral 102 through the network I/F 1015. The data to be transmitted may be the printing data itself, the intermediate language data 10163, and/or the control data 10166.

The second multifunction peripheral 102 acquires data from the first multifunction peripheral 101 through a network I/F 1025. The second multifunction peripheral 102 illustrated in FIG. 1 has the same configuration as that of the first multifunction peripheral 101 except that a finisher 1028 is mounted.

A controller 1026 interprets received print data by using an interpreter 10262. The controller 1026 simply passes the data received from the first multifunction peripheral 101 through if the received data is the previously-converted intermediate language data 10163 and/or control data 10166.

To receive the previously-converted intermediate language data 10163 and/or control data 10166 from the first multifunction peripheral 101, the second multifunction peripheral 102 needs to be able to interpret the same format as that of the first multifunction peripheral 101. Identical multifunction peripherals or multifunction peripherals of common specifications can perform interpretation.

Using the created intermediate language data 10263, a renderer 10267 generates a raster image 10268. The raster image 10268 is subjected to image processing 10269 for image processing. The resultant image is transmitted to a printer 1027 along with control data 10266.

The second multifunction peripheral 102 includes a finisher 1028. Sheets from a sheet discharge unit 10272 of the printer 1027 are fed into a sheet feeding unit 10281 of the finisher 1028 if a finishing operation such as stapling is requested by the control data 10266.

The finisher 1028 performs a finishing operation on the fed sheets, and outputs the resultant from a sheet discharge unit 10282.

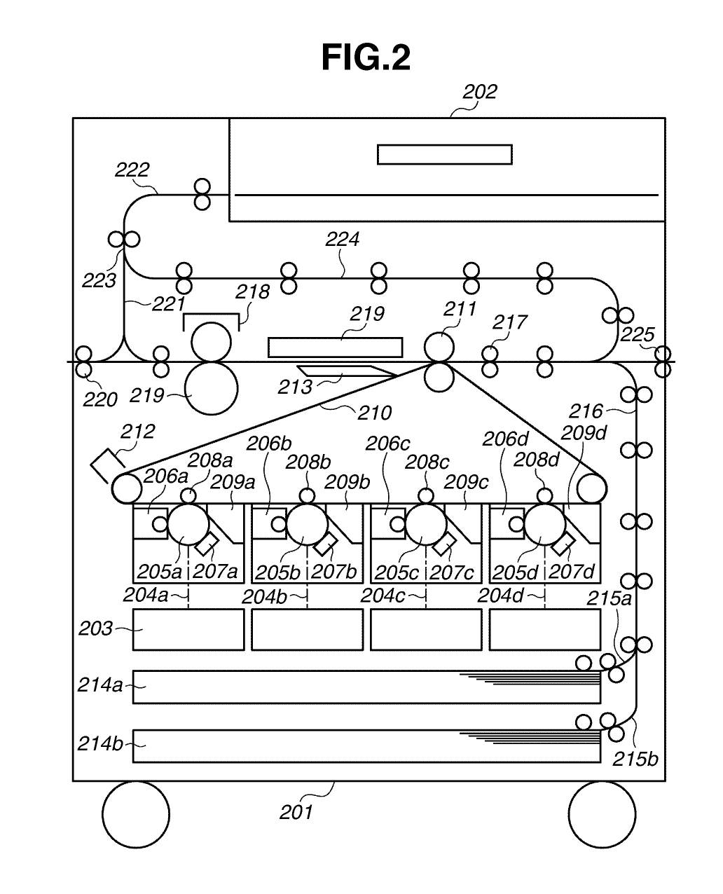

FIG. 2 illustrates diagram illustrating an example configuration of the hardware of the printers 1017 and 1027 in FIG. 1.

A multifunction peripheral main body 201 includes process units 204a, 204b, 204c, and 204d for forming primary images in a total of four colors, yellow, magenta, cyan, and black, individually. Images in the respective colors are formed on photosensitive drums 205a, 205b, 205c, and 205d of the process units 204a, 204b, 204c, and 204d, respectively.

An example of original to form an image include image data into which the data transmitted from the PC 104 over the network is converted by the controller 1016. Another example is image data that is read by an image reading apparatus 202 that includes the scanner 1022.

Laser scanners 203 of the respective colors emit laser to the photosensitive drums 205a to 205d, thereby drawing light images according to the image data. The process units 204a to 204d of the respective colors include charging devices 207a to 207d. The charging devices 207a to 207d uniformly charge the surfaces of the photosensitive drums 205a to 205d.

The process units 204a to 204d further include developing units 206a to 206d. The laser scanners 203a to 203d draw light images on the surfaces of the photosensitive drums 205a to 205d that are charged by the charging devices 207a to 207a. The developing units 206a to 206d develop the resulting electrostatic latent images into toner images.

The process units 204a to 204d include primary transfer rollers 208a to 208d. The primary transfer rollers 208a to 208d transfers the toner images developed on the surfaces of the photosensitive drums 205a to 205d to an intermediate transfer belt 210. The process units 204a to 204d include cleaning units 209a to 209d. The cleaning units 209a to 209d remove toner remaining on the photosensitive drums 205a to 205d after the transfer of the toner images.

The toner images primarily transferred to the intermediate transfer belt 210 are transferred to a sheet by a secondary transfer roller 211. In such a configuration, an image is formed on the underside (back side) of the sheet that has been conveyed.

A transfer belt cleaner 212 collects toner that is left untransferred at the secondary transfer roller 211. In this way, the process units 204a to 204d for forming primary images, the intermediate transfer belt 210, and the secondary transfer roller 211 perform image formation. A separation claw 213 is arranged on the downstream side of the secondary transfer roller 211. The separation claw 213 is used to separate sheet material if the sheet material adheres to the intermediate transfer belt 210.

Sheet feeding units 215a and 215b are located in the uppermost stream position of sheet conveyance. Two stages of sheet feeding cassettes 214a and 214b for storing sheets are arranged in the lower part of the multifunction peripheral main body 201. A sheet conveyed from a sheet feeding cassette is passed through a vertical conveyance path 216 and conveyed to registration rollers 217. The registration rollers 217 perform skew correction on the sheet, and synchronize the timing of sheet conveyance with that of image writing to be performed in an image forming part.

The multifunction peripheral main body 201 includes a fixing device 218 and a pre-fixing conveyance unit (rotating members) 219. After toner images are transferred to a sheet by the secondary transfer roller 211, the fixing device 218 fixes the toner images into a permanent image. The conveyance unit 219 suctions and conveys the sheet to the fixing device 218.

The fixing device 218 nips and conveys the sheet by using a pair of rotating members 219 while fixing the toner onto the sheet by using heat from a heat generation member and the nipping pressure between the rotating members 219. Past the fixing device 218, the conveyance path branches into a main conveyance path and a reversing path 221. Through the main conveyance path, a sheet is conveyed to discharge rollers 220 and discharged to a discharge tray. The reversing path 221 reverses a sheet to form images on both sides.

For two-sided image formation, the main conveyance path and the reversing path 221 are switched by a switch member. After an image is fixed on one side of a sheet, the sheet is conveyed to the reversing path 221 and to a switchback path 222.

After the trailing edge of the sheet passes through a branching point 223 of the switchback path 222, the sheet is once stopped and then conveyed in the reverse direction. The conveyance path is switched by a switch member and the sheet is conveyed to a two-sided conveyance path 224.

At that time, the image-formed side of sheet under printing is oriented downward. When the sheet is conveyed to the image forming part of the registration rollers (rotating rollers) 217 again, the side where no image is formed comes to face the intermediate transfer belt 210.

In such a manner, an image is transferred to the other side of the sheet. After the image is fixed by the fixing device 218, the sheet is passed through the main conveyance path and discharged to the discharge tray by the discharge rollers 220. If a sheet is fed from a manual feed tray through sheet feed rollers 225, the sheet is simply conveyed to the registration rollers 217 for image formation.

From the above-described configuration, it can be seen that the orientation (upward or downward) of the print side in which the multifunction peripheral illustrated in FIG. 2 discharges a sheet is face down. When an image forming apparatus having such a configuration performs two-sided printing face down, the image forming apparatus needs to form an image of the back page (even-numbered page) first, pass the sheet through the reversing path 221, and then form an image of the front page (odd-numbered page).

For example, in the case of a 7-page document, image formation is performed in order of the second, first, fourth, third, sixth, fifth, and seventh pages. If the entire document has an odd number of pages, the last sheet may seem to be one-sided printed. In fact, the last sheet is also passed through the reversing path 221 since the sheet needs to be discharged with the print side in proper orientation. Despite one-sided printing, processing similar to two-sided printing is thus performed.

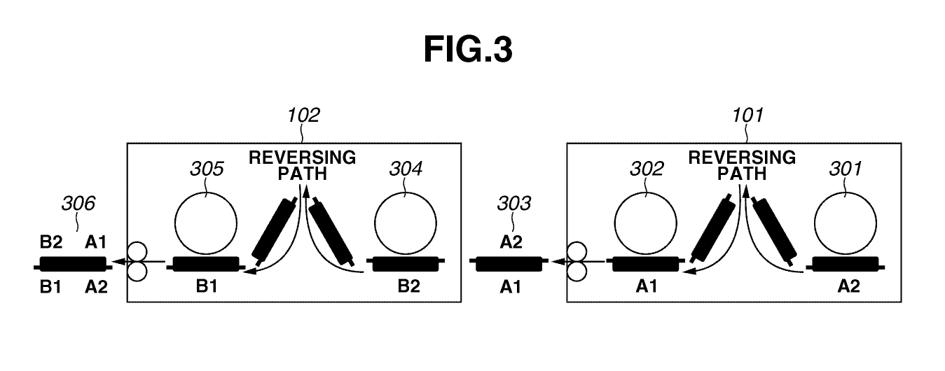

FIG. 3 illustrates print sides of a sheet and the state of the sheet in reversing paths in a printing system where the multifunction peripherals 101 and 102 having the configuration illustrated in FIG. 2 are connected. Herein, both the first multifunction peripheral 101 and the second multifunction peripheral 102 perform two-sided printing with no particular control on the print side when the sheet is discharging.

The multifunction peripherals 101 and 102 are illustrated to include two secondary transfer rollers each. In fact, there are not physically two secondary transfer rollers. The two rollers represent two transfer operations in two-sided printing.

First, the secondary transfer roller of the first multifunction peripheral 101 (301) transfers and fixes the second page (A2), an even-numbered page. Having the configuration illustrated in FIG. 2, the first multifunction peripheral 101 forms an image on the underside (back side) of the sheet.

Next, the sheet is passed and reversed through the reversing path. The second transfer roller (302) transfers and fixes the first page (A1), an odd-numbered page. The two-sided printed sheet is passed between the discharge rollers and discharged to the intermediate buffer (303). In this state, the sheet is face down, with the first page downward (on the back side), as with two-sided printing in an ordinary multifunction peripheral.

The sheet is simply conveyed to the manual feed tray of the second multifunction peripheral 102, and the second multifunction peripheral 102 successively performs two-sided printing on the sheet. The second multifunction peripheral 102 (304) transfers and fixes the second page (B2), an even-numbered page, to the underside (back side) of the fed sheet. The sheet is passed and reversed through the reversing path. The second transfer roller (305) transfers and fixes the first page (B1), an odd-numbered page.

The sheet 306 is finally discharged through the discharge rollers. The underside (back side) of the sheet carries the first page (B1) printed by the second multifunction peripheral 102, superposed on the second page (A2) printed by the first multifunction peripheral 101. This means a mismatch of superposed pages.

In such a printing system, pages printed by the first multifunction peripheral 101 and the second multifunction peripheral 102 do not appear on the same print sides of a sheet by performing only normal two-sided print processing.

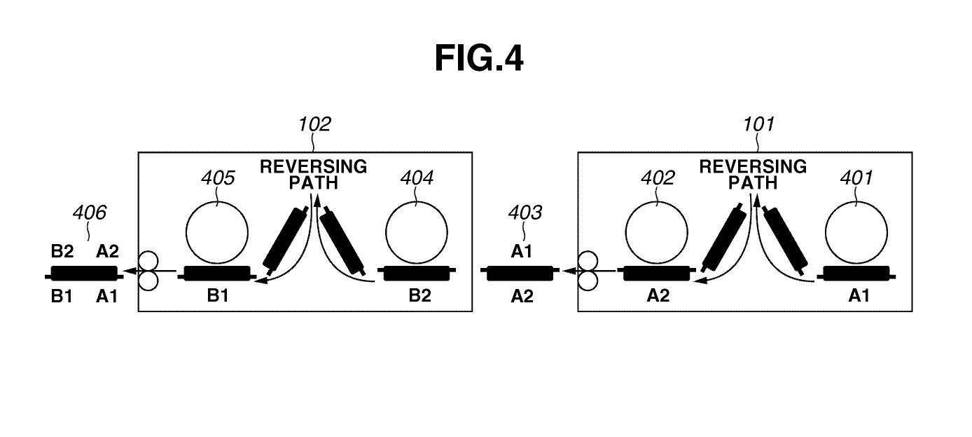

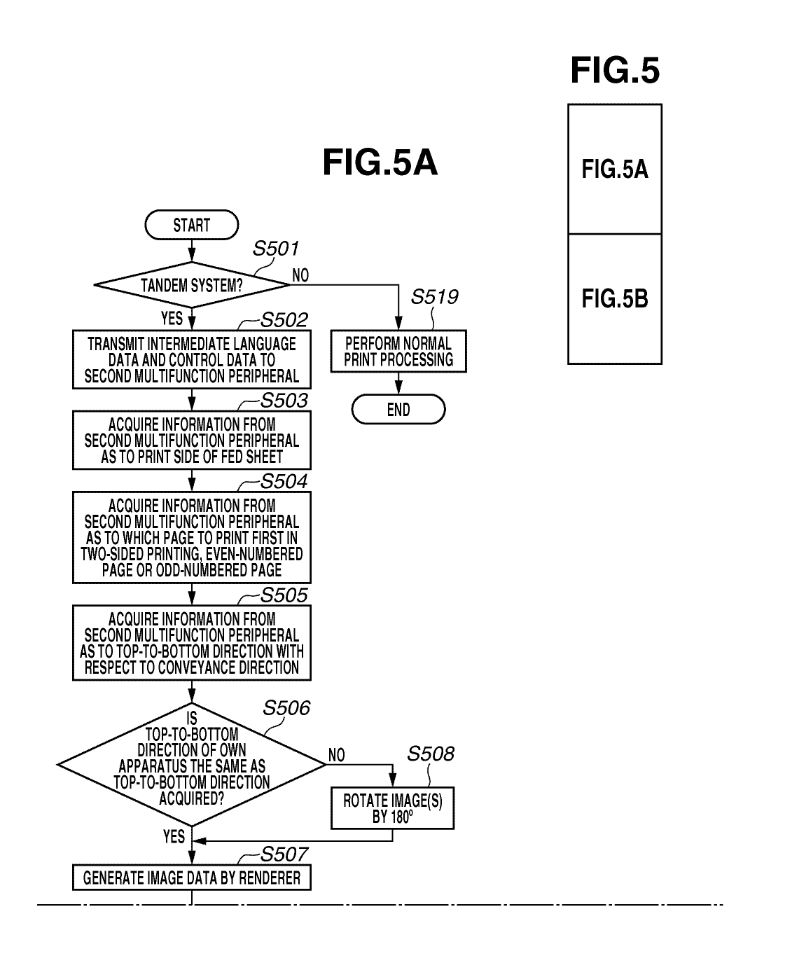

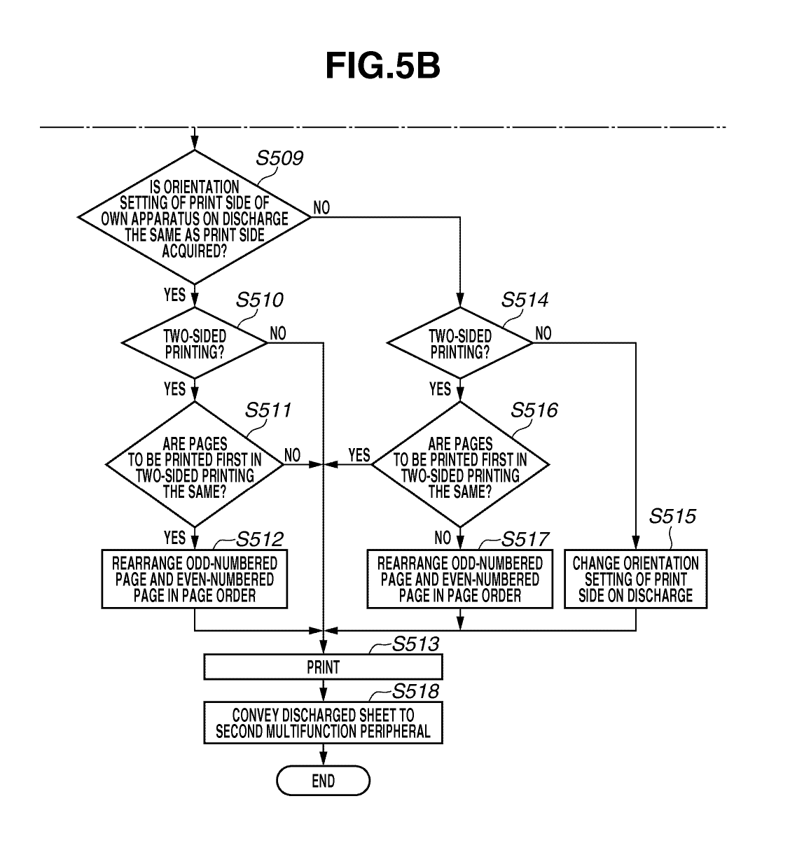

An operation for determining the order of images and designating the orientation of a print side in discharge, of the printing system according to the present exemplary embodiment will be described with reference to FIG. 4 and the flowchart of FIG. 5. Program code for implementing the steps of the procedure is stored in the storage device 1014 and executed by the CPU 10161.

In step S501, the first multifunction peripheral 101 receives a print job, and processes the print job by using the interpreter 10162, and determines whether the printing system includes a plurality of multifunction peripherals connected with each other. If the printing system is determined to be configured as such (YES in step S501), then in step S502, the first multifunction peripheral 101 transmits intermediate language data 10163 and control data 10166 generated by the interpreter 10162 to the second multifunction peripheral 102.

If the printing system does not include a plurality of multifunction peripherals connected (NO in step S501), then in step S519, the first multifunction peripheral 101 performs normal print processing.

In step S503, the first multifunction peripheral 101 acquires information on a print side from the second multifunction peripheral 102. The information indicates on which side of a fed sheet the second multifunction peripheral 102 forms and fixes an image first, a front side or a back side.

In step S504, the first multifunction peripheral 101 acquires information from the second multifunction peripheral 102 as to on which page the second multifunction peripheral 102 prints and fixes first in two-sided printing, an even-numbered page or an odd-numbered page.

If an apparatus has the hardware configuration illustrated in FIG. 2, the print side is the back side, and an even-numbered page is first printed in two-sided printing.

In step S505, the first multifunction peripheral 101 further acquires information from the second multifunction peripheral 102 as to the top-to-bottom direction in which the second multifunction peripheral 102 forms an image with respect to the conveyance direction. The top and bottom refer to vertical directions of an image. If an apparatus conveys a sheet along a longitudinal direction, the far side is the top and the near side is the bottom when the user faces the apparatus from the front.

In step S506, the first multifunction peripheral 101 determines whether the top-to-bottom direction of the own apparatus is the same as the top-to-bottom direction of the second multifunction peripheral 102, based on the information acquired from the second multifunction peripheral 102. If the top-to-bottom directions of the two multifunction peripherals 101 and 102 are different (NO in step S506), then in step S508, the first multifunction peripheral 101 rotates an image or images to be printed by the first multifunction peripheral 101 by 180°.

In step S507, the first multifunction peripheral 101 acquires all necessary information from the second multifunction peripheral 102, then, generates image data corresponding to each page by using the renderer 10164 or 10167, and performs image processing.

The first multifunction peripheral 101 communicates with the connected second multifunction peripheral 102 before the renderer 10164 or 10167 generates image data. This eliminates the need to communicate with the second multifunction peripheral 102 page by page, and minimizes deterioration in performance.

In step S509, the first multifunction peripheral 101 compares the current orientation setting of the print side of the own apparatus on discharge, indicated by the control data 10166, with the print side of the second multifunction peripheral 102 (first comparison) based on the information acquired in step S503. The first multifunction peripheral 101 then determines whether the orientation setting of the print side on discharge is the same as the acquired print side.

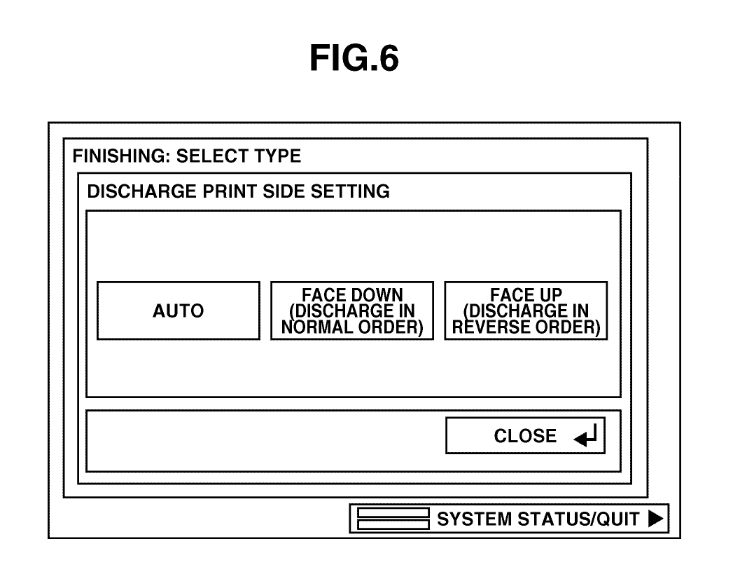

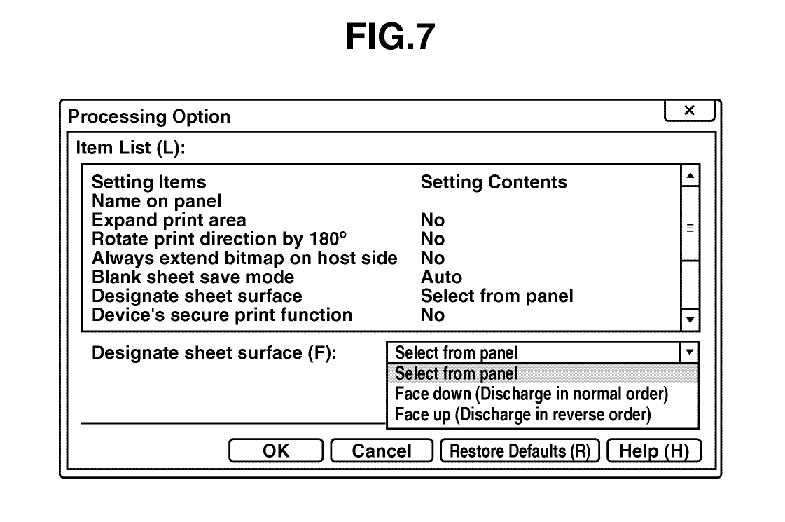

The current orientation of the print side in which the first multifunction peripheral 101 discharges a sheet may be set by using a screen displayed on the display device 1011 of the first multifunction peripheral 101 illustrated in FIG. 6. Alternatively, the current orientation may be set by using a user interface of the driver 1042 illustrated in FIG. 7.

At that time, the user need not designate the orientation of a print side on discharge for both the first multifunction peripheral 101 and the second multifunction peripheral 102. The user can make a final setting on an output product of the printing system by making a single designation with respect to the entire system.

In step S509, if the current orientation setting of the print side of the own apparatus on discharge, indicated by the control data 10166, is determined to be the same as the print side of the second multifunction peripheral 102 based on the information acquired in step S503 (YES in step S509), the processing of the first multifunction peripheral 101 proceeds to step S510.

In step S510, the first multifunction peripheral 101 determines whether the print job input to the printing system includes a two-sided print setting. If the input print job includes a two-sided print setting (YES in step S510), then in step S511, the first multifunction peripheral 101 compares the page the second multifunction peripheral 102 prints first in two-sided printing with that the own apparatus prints first in two-sided printing (second comparison). Based on the result of comparison, the first multifunction peripheral 101 determines whether the pages the two apparatuses print first are the same. The information about on which page the second multifunction peripheral 102 prints first, an odd-numbered page or an even-numbered page, has been acquired in step S504. The first multifunction peripheral 101 can make the determination by using the information.

If the first multifunction peripheral 101 and the second multifunction peripheral 102 are determined to print the same even-numbered or odd-numbered page first (YES in step S511), the situation is as illustrated in FIG. 3. In step S512, in order to solve a mismatch of print sides, the first multifunction peripheral 101 rearranges the page order of odd-numbered and even-numbered pages to change the first page to print. In step S513, the first multifunction peripheral 101 prints the input print job whose page order is decided as described above.

FIG. 4 illustrates an example where the first multifunction peripheral 101 has rearranged page order of an odd-numbered page and an even-numbered page. More specifically, the first multifunction peripheral 101 first fixes the first page (A1) (401), passes the sheet through the reversing path, and then fixes the second page (A2) (402). Unlike the case illustrated in FIG. 3, the first multifunction peripheral 101 discharges the sheet 403 face up.

The second multifunction peripheral 102 then performs two-sided printing, i.e., starts printing at an even-numbered page (404, 405). Because of the face-up discharge of the first multifunction peripheral 101, the image printed by the first multifunction peripheral 101 and the image printed by the second multifunction peripheral 102 appear on the same print sides. Consequently, the final output product is discharged without a mismatch (406).

As illustrated in FIG. 4, even if the orientation of the print side of a discharged sheet in an intermediate phase is face up, the printing system discharges a final output product face down. The data printed by the first multifunction peripheral 101 and the data printed by the second multifunction peripheral 102 thus appear on the same print sides of the same sheet.

Other cases will be described with reference to the flowchart in FIG. 5. If the print side of the second multifunction peripheral 102 is the same as the orientation setting of the print side of the first multifunction peripheral 101 on discharge, and the input print job includes a one-sided print setting (NO in step S510), then in step S513, the first multifunction peripheral 101 simply performs print processing.

In such a case, i.e., if the print side of the second multifunction peripheral 102 is the same as the orientation setting of the print side of the first multifunction peripheral 101 on discharge, and a one-sided print setting is included, data printed by the first multifunction peripheral 101 and data printed by the second multifunction peripheral 102 appear on the same print side. Since there is no mismatch, the order of images included in the input print job is determined as input order.

If the print side of the second multifunction peripheral 102 is the same as the orientation setting of the print side of the first multifunction peripheral 101 on discharge, and the input print job includes a two-sided print setting (YES in step S510), the processing of the first multifunction peripheral 101 proceeds to step S511. If the first multifunction peripheral 101 and the second multifunction peripheral 102 print odd-numbered and even-numbered, respective different pages first (NO in step S511), then in step S513, the first multifunction peripheral 101 simply performs print processing.

Printing odd-numbered and even-numbered, respective different pages first is equivalent to pages being rearranged. Since there is no mismatch, the order of images included in the input print job is determined as input order.

If the print side of the second multifunction peripheral 102 is different from the orientation setting of the print side of the first multifunction peripheral 101 on discharge (NO in step S509), then in step S514, the first multifunction peripheral 101 determines whether the input print job includes a two-sided print setting.

If the input print job includes a one-sided print setting (NO in step S514), then in step S515, the first multifunction peripheral 101 changes the orientation setting of the print side of the first multifunction peripheral 101 on discharge. More specifically, the first multifunction peripheral 101 switches the setting of a sheet to be discharged from the first multifunction peripheral 101 between face up and face down.

When the orientation setting of the print side of the first multifunction peripheral 101 on discharge is changed, the print side of a sheet input to the second multifunction peripheral 102 is reversed. This matches the print sides in orientation.

If the print side of the second multifunction peripheral 102 is different from the orientation setting of the print side of the first multifunction peripheral 101 on discharge, and the input print job includes a two-sided print setting (YES in step S514), the processing of the first multifunction peripheral 101 proceeds to step S516.

In step S516, the first multifunction peripheral 101 compares the page the second multifunction peripheral 102 prints first in two-sided printing with that the own apparatus prints first in two-sided printing (second comparison) for a match. Based on the comparison result, the first multifunction peripheral 101 determines whether the pages the two apparatuses print first are the same. If it is determined that the pages the two apparatuses print first are the same (YES in step S516), then in step S513, the first multifunction peripheral 101 performs print processing in unchanged order since the situation is as illustrated in FIG. 4.

If the page the own apparatus prints first is different from that the second multifunction peripheral 102 prints first and the print sides of the two multifunction peripherals 101 and 102 are different, the resulting situation is as illustrated in FIG. 3. In step S517, the first multifunction peripheral 101 rearranges the page order of odd-numbered and even-numbered pages. In step S513, the first multifunction peripheral 101 prints the input job whose page order is determined as described above.

In step S518, the first multifunction peripheral 101 discharges the sheet printed thus from the sheet discharge unit 10172, and conveys the sheet to the second multifunction peripheral 102. The sheet conveyed from the first multifunction peripheral 101 is fed into the second multifunction peripheral 102. The second multifunction peripheral 102 simply performs printing on the conveyed side.

As described above, using the present exemplary embodiment, the printing system determines whether to rearrange the order of pages for the first multifunction peripheral 101 to form images according to conditions. The printing system performs printing in the page order determined according to the determination.

The printing system including the plurality of multifunction peripherals 101 and 102 connected with each other can thus perform two-sided printing on a sheet without causing a page mismatch. Specifically, the first multifunction peripheral 101 and the second multifunction peripheral 102 can print data to be printed on the same pages.

Even in the case of one-sided printing, the first multifunction peripheral 101 can change the designation of the orientation of the print side on discharge according to conditions. One-sided printing can thus be performed without a page mismatch.

A mismatch of print sides can also be corrected by the second multifunction peripheral 102 rearranging images in order. Such a printing system, however, may produce a final output product with the designation of the print side on discharge in a reverse orientation. It is therefore more efficient to rearrange the order of images by the first multifunction peripheral 101.

When a printing system includes three or more multifunction peripherals connected with each other, a first multifunction peripheral 101 and a second multifunction peripheral 102 are first combined. Images to be processed are rearranged in order according to the result of the present exemplary embodiment, and based on the result, the present exemplary embodiment is applied again to a combination with a third multifunction peripheral. In such a manner, the printing system can provide the same effects as the foregoing.

In the printing system according to the first exemplary embodiment, one print job is passed to the second multifunction peripheral 102 from the first multifunction peripheral 101, and the first and second multifunction peripherals 101 and 102 perform printing by using the same job. On the other hand, according to a second exemplary embodiment of the present invention, a case is described where the first multifunction peripheral 101 and the second multifunction peripheral 102 separately receive print jobs from the PC 104, and print the print jobs on a single sheet of paper.

Data needed for the first multifunction peripheral 101 to perform printing will be referred to as first image data. Data needed for the second multifunction peripheral 102 to perform printing will be referred to as second image data.

The description is made using an example where the first multifunction peripheral 101 is a multifunction peripheral for performing color printing by using ordinary color recording agents such as C, M, Y, and K color toners, and the second multifunction peripheral 102 is a multifunction peripheral for performing clear printing by using a transparent recording agent or clear toner.

Clear toner, a kind of transparent recording agent used here, can be printed on an ordinary print surface to produce glossiness only on the printed areas. Printing clear toner on glossy paper, conversely, can produce matteness only on the printed areas.

Uniform application of clear toner to the entire print surface enables a glossy paper-like expression even on plain paper. Such an application will be referred to as whole surface clear printing. Watermarking a company logo on apart of a print surface will be referred to as partial clear printing.

Even with the printing system in which a multifunction peripheral for printing with color toners and a multifunction peripheral for printing with clear toner are connected, the apparatus configuration is the same as that illustrated in FIG. 1.

There is a difference, however, in that the application 1041 of the PC 104 gives instructions to transmit two print jobs, one dedicated to printing with clear toner and one for normal printing.

When transmitting the print job dedicated to printing with clear toner to the first multifunction peripheral 101, the driver 1042 adds to the control data the information indicating that the print job uses clear toner.

The first multifunction peripheral 101 interprets the received print job with the interpreter 10162. When the first multifunction peripheral 101 detects the information on clear toner, the first multifunction peripheral 101 inquires of the second multifunction peripheral 102 whether the second multifunction peripheral 102 is capable of printing with clear toner.

If the second multifunction peripheral 102 is found to be capable of printing with clear toner, the first multifunction peripheral 101 quits the interpretation of the interpreter 10162. The first multifunction peripheral 101 transmits the received print job to the second multifunction peripheral 102 through the network I/F 1015.

Receiving a print job with clear toner, the second multifunction peripheral 102 generates image data by the image processing 10269, and temporarily stores the image data in the storage device 1024. The second multifunction peripheral 102 then waits for a job for printing with clear toner to arrive from the first multifunction peripheral 101. Next, the application 1041 of the PC 104 transmits a normal print job to the first multifunction peripheral 101.

To perform printing with clear toner, the printer illustrated in FIG. 2 includes a clear toner process unit.

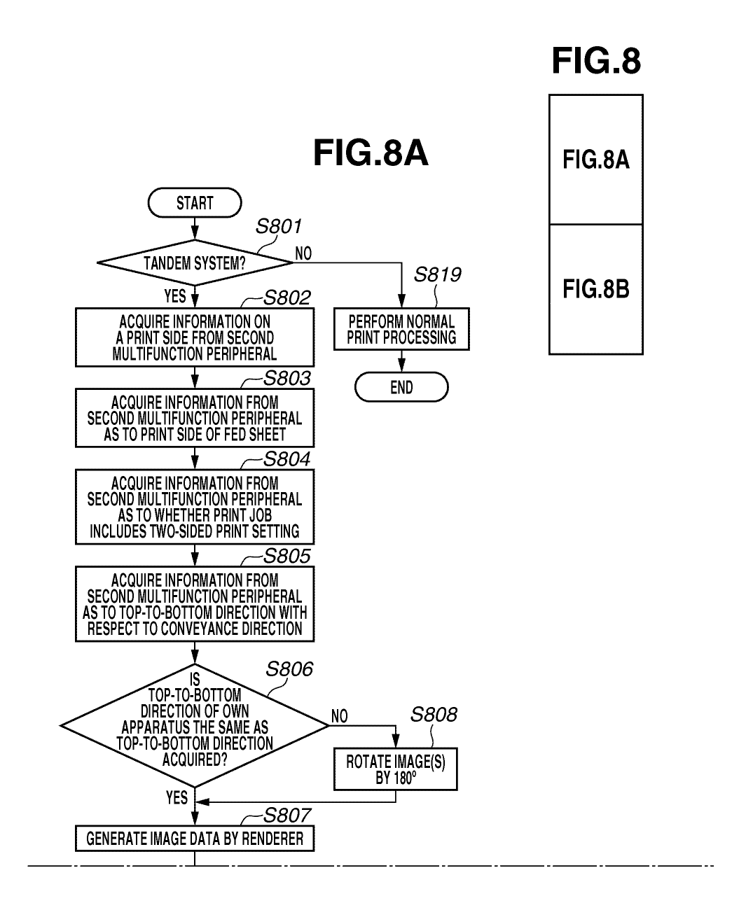

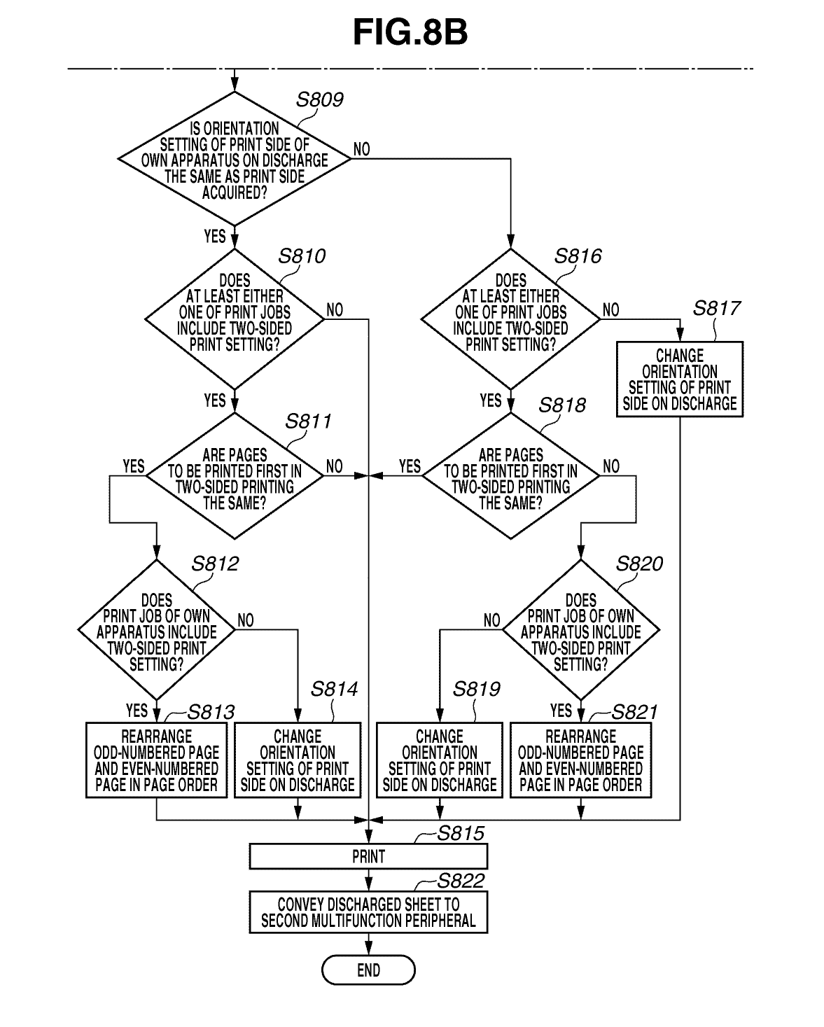

An operation by which the printing system according to the present exemplary embodiment determines the order of images and designates the orientation of a print side on discharge will be described below with reference to the flowchart of FIG. 8 (8A+8B). Program code for implementing the steps of the procedure is stored in the storage device 1014 and executed by the CPU 10161.

In step S801, the first multifunction peripheral 101 receives a print job, processes the print job by using the interpreter 10162, and determines whether the printing system includes a plurality of multifunction peripherals. If the printing system does not include a plurality of multifunction peripherals (NO in step S801), then in step S823, the first multifunction peripheral 101 performs normal print processing.

In step S802, the first multifunction peripheral 101 acquires information on a print side from the second multifunction peripheral 102. The information indicates which side of a fed sheet the second multifunction peripheral 102 forms and fixes an image on, a front side or a back side.

In step S803, the first multifunction peripheral 101 acquires information from the second multifunction peripheral 102 as to which page the second multifunction peripheral 102 prints first when performing two-sided printing, an even-numbered page or an odd-numbered page.

If an apparatus has the hardware configuration illustrated in FIG. 2, the print side is the back side and the first page to print is an even-numbered page.

In step S804, the first multifunction peripheral 101 acquires information from the second multifunction peripheral 102 as to whether the print job for the second multifunction peripheral 102 to print includes a two-sided print setting.

In step S805, the first multifunction peripheral 101 further acquires information from the second multifunction peripheral 102 as to the top-to-bottom direction in which the second multifunction peripheral 102 forms an image with respect to the conveyance direction. The top and bottom refer to vertical directions of an image. If an apparatus conveys a sheet along a longitudinal direction, the far side is the top and the near side the bottom when the user faces the apparatus from the front.

In step S806, the first multifunction peripheral 101 determines whether the top-to-bottom direction of the own apparatus is the same as the top-to-bottom direction of the second multifunction peripheral 102, based on the information acquired from the second multifunction peripheral 102. If the top-to-bottom directions of the two multifunction peripherals 101 and 102 are different (NO in step S806), then in step S808, an image to be printed by the first multifunction peripheral 101 is rotated by 180°.

In step S807, the first multifunction peripheral 101 acquires all necessary information from the second multifunction peripheral 102, generates image data corresponding to each page by using the renderer 10164 or 10167, and performs image processing.

In step S809, the first multifunction peripheral 101 compares the current orientation setting of the print side of the own apparatus on discharge, indicated by the control data 10166, with the print side of the second multifunction peripheral 102 (first comparison) based on the information acquired in step S802. The first multifunction peripheral 101 determines whether the print sides are the same.

Like the first exemplary embodiment, the current orientation of the print side in which the first multifunction peripheral 101 discharges a sheet may be set by using a screen displayed on the display device 1011 of the first multifunction peripheral 101 illustrated in FIG. 6. Alternatively, the current orientation may be set by using a user interface of the driver 1042 illustrated in FIG. 7.

Here, the user need not designate the orientation of a print side on discharge for both the first multifunction peripheral 101 and the second multifunction peripheral 102. The user can make a final setting of the printing system by making a single designation with respect to the entire system.

If the orientation of the print side of the second multifunction peripheral 102 and the orientation setting of the print side of the own apparatus on discharge are determined to be the same based on the information acquired in step S802 (YES in step S809), the processing of the first multifunction peripheral 101 proceeds to step S810.

In step S810, the first multifunction peripheral 101 determines if the print job input to the first multifunction peripheral 101 or the print job input to the second multifunction peripheral 102 includes a two-sided print setting.

If at least either one of the input print jobs includes a two-sided print setting (YES in step S810), then in step S811, the first multifunction peripheral 101 determines which page the second multifunction peripheral 102 prints first in two-sided printing, an odd-numbered page or an even-numbered page. The first multifunction peripheral 101 compares the result of determination with the first page that the own apparatus prints in two-sided printing (second comparison) to see if the first pages are the same. The first multifunction peripheral 101 determines whether the pages that the two apparatuses print first are the same, based on the result of comparison.

In step S811, if the pages that the first multifunction peripheral 101 and the second multifunction peripheral 102 print first are the same (YES in step S811), then in step S812, the first multifunction peripheral 101 further determines whether the print job of the first multifunction peripheral 101 includes a two-sided print setting.

In step S812, if the print job input to the first multifunction peripheral 101 includes a two-sided print setting (YES in step S812), the processing of the first multifunction peripheral 101 proceeds to step S813. In step S813, in order to resolve a page mismatch, the first multifunction peripheral 101 rearranges page order of odd-numbered and even-numbered pages to change the first page to print. In step S815, the first multifunction peripheral 101 prints the input job whose page order is determined as described above.

If the print side of the second multifunction peripheral 102 is the same as the orientation setting of the print side of the first multifunction peripheral 101 on discharge, and the print jobs of both the first multifunction peripheral 101 and the second multifunction peripheral 102 include a one-sided print setting (NO in step S810), then in step S815, the first multifunction peripheral 101 simply perform print processing.

With the one-sided print settings, the data printed by the first multifunction peripheral 101 and the data printed by the second multifunction peripheral 102 appear on the same print side without a mismatch.

If the orientation setting of the print side of the own apparatus on discharge is determined to be the same as the print side of the second multifunction peripheral 102 based on the information acquired in step S802 and the print jobs to be processed by the multifunction peripherals 101 and 102 include a two-sided print setting (YES in step S810), the processing of the first multifunction peripheral 101 proceeds to step S811. In step S811, the first multifunction peripheral 101 judges whether the pages that the respective multifunction peripherals 101 and 102 print first are the same. If the pages to be printed first are different (NO in step S811), the processing of the first multifunction peripheral 101 proceeds to step S815, and simply performs print processing. The reason is that printing different pages first is equivalent to that the pages have been rearranged.

If the print side of the second multifunction peripheral 102 is the same as the orientation setting of the print side of the first multifunction peripheral 101, the pages to be printed first are the same, and the print job of the own apparatus includes a one-sided print setting and the print job of the second multifunction peripheral 102 includes a two-sided print setting (NO in step S812), the processing of the first multifunction peripheral 101 proceeds to step S814.

In step S814, the first multifunction peripheral 101 changes the designation of the orientation of the print side on discharge, thereby switching the setting of a sheet to be discharged from the first multifunction peripheral 101 between face up and face down. The processing of the first multifunction peripheral 101 then proceeds to step S815, and prints the print job input to the first multifunction peripheral 101 based on the switched setting. The reason is that the orientation of the print side, in which the sheet output in one-sided printing is discharged, needs to be matched with the side to be printed first in two-sided printing.

In step S809, if it is determined that the print side of the second multifunction peripheral 102 is different from the orientation setting of the print side of the first multifunction peripheral 101 on discharge (NO in step S809), the processing of the first multifunction peripheral 101 proceeds to step S816.

In step S816, the first multifunction peripheral 101 determines if the print job input to the first multifunction peripheral 101 or the print job input to the second multifunction peripheral 102 includes a two-sided print setting.

In step S816, if both the print jobs include a one-sided print setting (NO in step S816), then in step S817, the first multifunction peripheral 101 changes the orientation setting of the print side on discharge. In other words, the first multifunction peripheral 101 switches between face up and face down. When the orientation setting of the print side of the first multifunction peripheral 101 on discharge is changed, the print side at the time of input to the second multifunction peripheral 102 is reversed. This results in a match between the orientations of the print sides.

If the print side of the second multifunction peripheral 102 is different from the orientation setting of the print side of the first multifunction peripheral 101 on discharge (NO in step S809), the processing of the first multifunction peripheral 101 proceeds to step S816.

If either one of the print jobs input to the multifunction peripherals 101 and 102 includes a two-sided print setting (YES in step S816), then in step S818, the first multifunction peripheral 101 determines whether the page that the second multifunction peripheral 102 prints first in two-sided printing is the same as that the own apparatus prints first in two-sided printing.

If the page the first multifunction peripheral 101 prints first is the same as that the second multifunction peripheral 102 prints first (YES in step S818), then the print sides are different. In such a situation, the first multifunction peripheral 101 and the second multifunction peripheral 102 can perform printing on the same sides of the same sheet. In step S815, the first multifunction peripheral 101 therefore performs print processing in the page order that is determined to be kept unchanged.

In step S818, if the page that the first multifunction peripheral 101 prints first is different from that the second multifunction peripheral 102 prints first, and the print side of the second multifunction peripheral 102 is judged to be different from the setting of the print side of the first multifunction peripheral 101 (NO in step S818), the processing of the first multifunction peripheral 101 proceeds to step S820.

In step S820, the first multifunction peripheral 101 determines whether the print job input to the own apparatus includes a two-sided print setting.

In step S820, if the print job input to the own apparatus includes a two-sided print setting (YES in step S820), then in step S821, the first multifunction peripheral 101 rearranges the page order of odd-numbered and even-numbered pages input to the first multifunction peripheral 101. In step S815, the first multifunction peripheral 101 prints the print job in the page order rearranged in step S821.

If the page the first multifunction peripheral 101 prints first is different from that the second multifunction peripheral 102 prints first and the print side of the second multifunction peripheral 102 is different from the setting of the print side of the first multifunction peripheral 101 (NO in step S818), the processing of the first multifunction peripheral 101 proceeds to step S820.

If the print job input to the own apparatus includes a one-sided print setting and the print job input to the second multifunction peripheral 102 includes a two-sided setting (NO in step S820), then in step S819, the first multifunction peripheral 101 changes the orientation setting of the print side of the first multifunction peripheral 101 on discharge. In step S815, the first multifunction peripheral 101 performs printing.

In step S822, the first multifunction peripheral 101 discharges the sheet printed thus from the sheet discharge unit 10172, and conveys the sheet to the second multifunction peripheral 102. The sheet conveyed from the first multifunction peripheral 101 is fed into the second multifunction peripheral 102. The second multifunction peripheral 102 simply performs printing on the conveyed side.

As described above, even when different print jobs are input to the first multifunction peripheral 101 and the second multifunction peripheral 102, the printing system including the plurality of multifunction peripherals 101 and 102 can print the print jobs without causing a page mismatch by simply determining whether each job includes two-sided printing.

If the print job to be processed by the second multifunction peripheral 102 includes whole surface clear printing, the same image is printed on both sides. This eliminates the need for the operation of switching page order (steps S813 and S821). If the print job is determined to include whole surface clear printing, processing can be performed without rearranging page order. This allows improved performance.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-091168 filed Apr. 15, 2011, which is hereby incorporated by reference herein in its entirety.

What is claimed is:

1. A printing system configured so that a sheet discharge unit of a first image forming apparatus is connected to a sheet feeding unit of a second image forming apparatus and a sheet on which an image is formed by the first image forming apparatus is supplied to the second image forming apparatus, the first image forming apparatus being configured to form an image of first image data included in an input print job, the second image forming apparatus being configured to form an image of second image data included in the input print job, the printing system comprising:
an input unit configured to input a print job including the first image data and the second image data;
a determination unit configured to determine order of printing of the first image data to be used for forming an image by the first image forming apparatus or the second image data to be used for forming an image by the second image forming apparatus so that the second image data to be printed on the same side of a sheet output from the sheet discharge unit of the first image forming apparatus as the side on which the first image data is printed, is printed on the same side of the output sheet as the side on which the first image data is printed; and
a print unit configured to print the print job input by the input unit in the order determined by the determination unit.

2. The printing system according to claim 1, further comprising a designation unit configured to designate an orientation of a print side in which the second image forming apparatus discharges a sheet, and
wherein the determination unit determines the order of printing so that the sheet can be output with a print side as designated by the designation unit.

3. An image forming apparatus comprising:
a judgment unit configured to judge an orientation of a print side to discharge a printed sheet;
an acquisition unit configured to acquire information from another image forming apparatus connected to the image forming apparatus, the information indicating which side, back or front, of a sheet fed into a sheet feeding unit of the another image forming apparatus is a print side;
a first comparison unit configured to compare the print side judged by the judgment unit with the print side of the another image forming apparatus connected to the image forming apparatus, acquired by the acquisition unit;
a second comparison unit configured to detect which page the another image forming apparatus connected to the image forming apparatus prints first, an odd-numbered page or an even-numbered page, when a job with a two-sided print setting is input, and compare a result of the detection with a page that the image forming apparatus prints first to determine if the pages to be printed first are the same;
a rearrangement unit configured to rearrange, when an input print job includes a two-sided print setting, page order of an odd-numbered page and an even-numbered page constituting the input print job to rearrange order of image formation if a result of the first comparison shows that the orientation of the print side to discharge the printed sheet is the same as that of the print side of the another image forming apparatus connected to the image forming apparatus and a result of the second comparison shows that the pages to be printed first are the same, or if the result of first comparison shows that the orientation of the print side to discharge the printed sheet in is different from that of the print side of the another image forming apparatus connected to the image forming apparatus and the result of the second comparison shows that the pages to be printed first are different;
a print unit configured to print images in order rearranged by the rearrangement unit; and
a conveyance unit configured to convey a sheet printed by the print unit to the sheet feeding unit of the another image forming apparatus connected to the image forming apparatus.

4. The image forming apparatus according to claim 3, further comprising a change unit configured to change, when the input print job includes a one-sided print setting, a setting of the orientation of the print side to discharge the printed sheet, judged by the judgment unit if the result of comparison of the first comparison unit shows that the orientation of the print side to discharge the printed sheet in is different from that of the print side of the another image forming apparatus connected.

5. The image forming apparatus according to claim 3, further comprising a determination unit configured to determine, when a print job different from the input print job is input to the another image forming apparatus connected to the image forming apparatus, whether at least either one of the print job input to the image forming apparatus and the print job input to the another image forming apparatus connected to the image forming apparatus includes a two-sided printing setting, and
wherein the rearrangement unit rearranges order of pages to form an image if the result of comparison of the first comparison unit shows that the orientation of the print side to discharge the printed sheet is the same as that of the print side of the another image forming apparatus connected, the result of comparison of the second comparison unit shows that the pages to be printed first are the same, and the determination unit determines that the print job input to the image forming apparatus includes a two-sided print setting, or if the result of comparison of the first comparison unit shows that the orientation of the print side to discharge the printed sheet is different from that of the print side of the another image forming apparatus connected to the image forming apparatus, the result of comparison of the second comparison unit shows that the pages to be printed first are different, and the determination unit determines that the print job input to the image forming apparatus includes a two-sided print setting.

6. The image forming apparatus according to claim 3, wherein the image forming apparatus acquires a top-to-bottom direction of an image formed by the another image forming apparatus connected to the image forming apparatus, determines whether the top-to-bottom direction is the same as that of the image forming apparatus, and if a result of the determination shows that the top-to-bottom directions are different, rotates an image to form by 180°.

7. The image forming apparatus according to claim 3, wherein the another image forming apparatus connected to the image forming apparatus performs printing by using a transparent recording agent.

8. A method for controlling a printing system configured so that a sheet discharge unit of a first image forming apparatus is connected to a sheet feeding unit of a second image forming apparatus and a sheet on which an image is formed by the first image forming apparatus is supplied to the second image forming apparatus, the first image forming apparatus being configured to form an image of first image data included in an input print job, the second image forming apparatus being configured to form an image of second image data included in the input print job, the method comprising:
inputting a print job including the first image data and the second image data;
determining order of printing of the first image data to be used for forming an image by the first image forming apparatus or the second image data to be used for forming an image by the second image forming apparatus so that the second image data to be printed on the same side of a sheet output from the sheet discharge unit of the first image forming apparatus as the side on which the first image data is printed, is printed on the same side of the output sheet as the side on which the first image data is printed; and
printing the input print job in the determined order.

9. The method for controlling a printing system according to claim 8, further comprising:
designating an orientation of a print side in which the second image forming apparatus discharges a sheet, and
determining the order of printing so that a sheet can be output with a print side as designated by the designating.

10. A method for controlling an image forming apparatus, comprising:
judging an orientation of a print side to discharge a printed sheet;
acquiring information from another image forming apparatus connected to the image forming apparatus, the information indicating which side, back or front, of a sheet fed into a sheet feeding unit of the another image forming apparatus is a print side;
performing first comparison for comparing the judged print side with the acquired print side of the another image forming apparatus connected to the image forming apparatus;
detecting which page the another image forming apparatus connected to the image forming apparatus prints first, an odd-numbered page or an even-numbered page, when a job with a two-sided print setting is input, and performing second comparison for comparing a detected result with a page that the image forming apparatus prints first to determine if the pages to be printed first are the same;
rearranging, when an input print job includes a two-sided print setting, page order of an odd-numbered page and an even-numbered page constituting the input print job to rearrange order of image formation if a result of the first comparison shows that the orientation of the print side to discharge the printed sheet is the same as that of the print side of the another image forming apparatus connected to the image forming apparatus and a result of the second comparison shows that the pages to be printed first are the same, or if the result of first comparison shows that the orientation of the print side to discharge the printed sheet in is different from that of the print side of the another image forming apparatus connected to the image forming apparatus and the result of the second comparison shows that the pages to be printed first are different;
printing images formed in the rearranged order; and
conveying a printed sheet to the sheet feeding unit of the another image forming apparatus connected to the image forming apparatus.

11. The method for controlling an image forming apparatus according to claim 10, further comprising changing, when the input print job includes a one-sided print setting, a setting of the orientation of the print side to discharge the printed sheet, if the result of first comparison shows that the orientation of the print side to discharge the printed sheet is different from that of the print side of the another image forming apparatus connected to the image forming apparatus.

12. The method for controlling an image forming apparatus according to claim 10, further comprising:
determining, when a print job different from the input print job is input to the another image forming apparatus connected to the image forming apparatus, whether at least either one of the print job input to the image forming apparatus and the print job input to the another image forming apparatus connected to the image forming apparatus includes a two-sided printing setting, and
rearranging order of pages to form an image on if the result of first comparison shows that the orientation of the print side to discharge the printed sheet is the same as that of the print side of the another image forming apparatus connected to the image forming apparatus, the result of second comparison shows that the pages to be printed first are the same, and the print job input to the image forming apparatus is determined to include a two-sided print setting, or if the result of first comparison shows that the orientation of the print side to discharge the printed sheet in is different from that of the print side of the another image forming apparatus connected, the result of second comparison shows that the pages to be printed first are different, and the print job input to the image forming apparatus is determined to include a two-sided print setting.

13. The method for controlling an image forming apparatus according to claim 10, further comprising:
acquiring a top-to-bottom direction of an image formed by the another image forming apparatus connected to the image forming apparatus with respect to a conveyance direction of a sheet in the another image forming apparatus connected to the image forming apparatus, and
determining whether the top-to-bottom direction is the same as that of the image forming apparatus, and if a result shows that the top-to-bottom directions are different, rotating an image to form by 180°.

14. The method for controlling an image forming apparatus according to claim 10, wherein the another image forming apparatus connected to the image forming apparatus performs printing by using a transparent recording agent.

15. A non-transitory computer-readable storage medium containing a program for causing a computer to execute the method for controlling a printing system according to claim 8.

16. A non-transitory computer-readable storage medium containing a program for causing a computer to execute the method for controlling an image forming apparatus according to claim 10.
